(19) United States
(12) Patent Application Publication
(10) Pub. No.: US 2007/0286207 A1
(43) Pub. Date: Dec. 13, 2007

(54) Hybrid IP/ATM NT and method of providing hybrid IP/ATM network termination

(75) Inventors: Safa Almalki, Nepean (CA); Lucien Marcotte, Ottawa (CA); Wajih Bishtawi, Kanata (CA); Bo Liu, Kanata (CA); Steve Driediger, Kanata (CA); Bernard Safarian, Ottawa (CA); Luc Vermoesen, Bornem (BE); Luc Hordies, Lochristi (BE); Danny Pierre Van der Elst, Deinze (BE); Todd Richard Sleigh, Kanata (CA); Haithem El-Abed, Ottawa (CA)

Correspondence Address: KRAMER & AMADO, P.C., 1725 DUKE STREET, SUITE 240, ALEXANDRIA, VA, 22314, US

(73) Assignee: ALCATEL, Paris (FR)

(21) Appl. No.: 11/448,771

(22) Filed: Jun. 8, 2006

(51) Int. Cl. H04L 12/56

(52) U.S. Cl. 370/395.52; 370/401

(57) ABSTRACT

A hybrid IP/ATM NT and method are provided for hybrid IP/ATM network termination. While traversing a DSLAM, ATM traffic over ATM network infrastructure and GigE/IP traffic over GigE/IP network infrastructure may be recast into crossover GigE/IP traffic and crossover ATM traffic respectively, and routed to the opposite kind of network infrastructure with use of the IP/ATM NT and hybrid IP/ATM network termination.

### FIELD OF THE INVENTION

The invention relates to digital subscriber line access multiplexers (DSLAMs), and more particularly to a hybrid IP/ATM NT (network termination) card and the provision of hybrid IP/ATM network termination.

### BACKGROUND OF THE INVENTION

In providing services to customers, network service providers are constantly trying to provide faster, more robust services, and to provide more bandwidth to customers of their communications networks. ATM is currently deployed heavily for DSL services. Service providers who possess large ATM based network infrastructures are moving towards GigE (gigabit ethernet)/IP based infrastructure because of the benefits provided by a GigE/IP based infrastructure including the delivery of enhanced features, more bandwidth, faster service, and more features to customers.

Referring to FIG. 1A, a known ATM NT (network termination) card 16 of an ATM DSLAM employed in an ATM based infrastructure is discussed. The ATM NT 16 has an ATM network interface 13 connected to an ATM based uplink 12 such as OC12, OC3, DS3, and DS1, and others. The ATM NT 16 has an ATM switch 14. The ATM switch 14 of the ATM NT 16 is connected to an ATM bus interface 19 which is connected by an ATM point to multipoint bus 18 to ATM LT (line termination) cards 20 of the ATM DSLAM. The ATM bus 18 has an ATM extension chain 204 for additional ATM devices. The ATM NT 16 has an ATM OBC (on board controller) 17 to control its operations. The ATM OBC 17 controls the ATM switch 14 via ATM switch control line 15, and by signals passed over the ATM bus 18 manages the ATM LT cards 20.

The ATM NT 16 of an ATM DSLAM is designed to work with ATM network rules. An ATM DSLAM typically provides limited functionalities and relatively low speed services such as HSI (High Speed Internet) over ADSL (Asymmetric Digital Subscriber Line) to end users.

ATM DSLAMs utilize ATM hardware, shelving and ATM LTs 20, and are designed to work with existing ATM system interfaces, and form part of an existing ATM network infrastructure.

Referring to FIG. 1B, a known GigE/IP NT card 56 of a GigE/IP DSLAM employed in a GigE/IP based infrastructure is discussed. The GigE/IP NT 56 has a GigE/IP network interface 53 connected to GigE/IP based uplinks 52. The GigE/IP NT 56 has a GigE/IP switch 54. The GigE/IP switch 54 of the GigE/IP NT 56 is connected to a GigE/IP bus interface 59 which is connected by a GigE/IP star bus 58 to GigE/IP LT cards 60 of the GigE/IP DSLAM. The GigE/IP NT 56 has a GigE/IP OBC (on board controller) 57 to control its operations. The GigE/IP OBC 57 controls the GigE/IP switch 54 via GigE/IP switch control line 55 and by signals passed over the GigE/IP bus 58 manages the GigE/IP LT cards 60.

The GigE/IP NT 56 of a GigE/IP DSLAM is designed to work with GigE/IP network rules. In general, a GigE/IP NT 56 provides more bandwidth both on its GigE/IP network interface 53 and over its GigE/IP bus interface 59 to the GigE/IP LT cards 60 of a GigE/IP DSLAM, than an ATM NT 16 provides on its ATM network interfaces 12 and over its ATM bus interface 19 to the ATM LT cards 20 of an ATM DSLAM.

Due to the multiple GigE/IP interfaces towards the network a GigE/IP DSLAM can provide, over high speed DSL (SHDSL and VDSL), high speed services such as Video, Voice, VoIP, IPTV, and HSI to its end users and allows for such capabilities as TV broadcasting using phone lines.

Although an ATM DSLAM could also provide high speed DSL services to end users, due to the bandwidth restrictions imposed by the ATM infrastructure, fewer subscribers could be serviced in this way by an ATM DSLAM than a GigE/IP DSLAM.

Service providers have an extensive installed base of ATM DSLAM systems. As these operators begin to evolve their access networks from ATM based infrastructure towards an infrastructure based on Ethernet packet aggregation, they begin to migrate from their existing installed base of ATM DSLAM systems to GigE/IP DSLAM systems.

Service providers would rather not have to resort to dropping new GigE/IP DSLAM systems into their networks as replacements of the ATM DSLAM systems due to the cost of the GigE/IP DSLAMs, the cost of empty slots in those GigE/IP DSLAMs during the transition, and the amount of new space required for the new GigE/IP DSLAMs. The service providers would prefer a solution that could support both ATM and GigE/IP system interfaces and help them continue to utilize the shelves and ATM line cards that they have already paid for to facilitate a gradual migration from an ATM network infrastructure to a GigE/IP network infrastructure.

### SUMMARY OF THE INVENTION

According to one aspect, the invention provides for a hybrid IP/ATM NT for a DSLAM, the hybrid IP/ATM NT comprising: a GigE/IP NT module for network termination and control of GigE/IP traffic flowing between a GigE/IP LT card and a GigE/IP uplink; an ATM NT module for network termination and control of ATM traffic flowing between an ATM LT card and an ATM uplink; and an IP/ATM bridge for recasting GigE/IP traffic received from the GigE/IP NT module into crossover ATM traffic and passing said crossover ATM traffic to the ATM NT module, and for recasting ATM traffic received from the ATM NT module into crossover GigE/IP traffic and passing said crossover GigE/IP traffic to the GigE/IP NT module.

In some embodiments of the invention the GigE/IP NT module comprises a GigE/IP switch for switching GigE/IP traffic, wherein the ATM NT module comprises an ATM switch for switching ATM traffic, and wherein the IP/ATM bridge comprises an inter-working function (IWF) element connected to said GigE/IP switch and connected to said ATM switch, said IWF element adapted to: recast GigE/IP traffic received from the GigE/IP switch into crossover ATM traffic; transmit said crossover ATM traffic to said ATM switch; recast ATM traffic received from the ATM switch into crossover GigE/IP traffic; and transmit the crossover GigE/IP traffic to said GigE/IP switch.

In some embodiments of the invention said IWF element is adapted to recast said GigE/IP traffic by: extracting a first payload and a VLAN ID from Ethernet packets of the GigE/IP traffic; finding in a look-up table a VPI/VCI (virtual path identifier/virtual channel identifier) corresponding to said VLAN ID; and inserting the first payload into ATM cells of the ATM data stream, ensuring the ATM cells are tagged with the VPI/VCI to generate said crossover ATM traffic; and wherein said IWF element is adapted to recast said ATM traffic by: extracting a second payload and a VPI/VCI from ATM cells of the ATM traffic; finding in said look-up table a VLAN ID corresponding to said VPI/VCI; and inserting said second payload into Ethernet packets of the GigE/IP data stream, ensuring the Ethernet packets are tagged with the VLAN ID to generate said crossover GigE/IP traffic.

In some embodiments of the invention the GigE/IP NT module comprises a GigE/IP OBC (on board controller) and manages the GigE/IP LT card, and the ATM NT module comprises an ATM OBC and manages the ATM LT card.

In some embodiments of the invention the ATM NT module is adapted to interface with standard ATM hardware and provide a standard ATM system interface.

In some embodiments of the invention the ATM NT module comprises an ATM bus interface for connecting over an ATM bus to a standard ATM LT card and a standard ATM network interface for connecting to the ATM uplink.

Some embodiments of the invention provide for a resource sharing switch multiplexer having a first access interface coupled to a first resource interface of the ATM NT module, a second access interface coupled to a second resource interface of the GigE/IP NT module, and a single resource interface coupled to a resource to be shared between the GigE/IP NT module and the ATM NT module; and a resource sharing controller coupled to the resource sharing switch multiplexer for switching said resource sharing switch multiplexer for one of throughput between the first access interface and the single resource interface and throughput between the second access interface and the single resource interface.

According to another aspect, the invention provides for a hybrid IP/ATM NT for a DSLAM, the hybrid IP/ATM NT comprising: a GigE/IP bus interface for connecting to a GigE/IP LT card over a GigE/IP star bus; a GigE/IP network interface for connecting to a GigE/IP uplink; a GigE/IP switch connected to said GigE/IP bus interface and said GigE/IP network interface, for switching traffic flowing between the GigE/IP LT card and the GigE/IP uplink; a GigE/IP OBC for managing the GigE/IP LT; an inter-working function (IWF) element; a GigE/IP connection coupling said GigE/IP switch to said IWF element; an ATM bus interface for connecting to an ATM LT card over an ATM bus; an ATM OBC for managing the ATM LT; an ATM network interface for connecting to an ATM uplink; an ATM switch for switching traffic flowing between the ATM LT and the ATM uplink; and an ATM connection coupling said IWF element to said ATM switch; wherein the IWF element is adapted to: receive GigE/IP traffic from said GigE/IP switch over said GigE/IP connection; recast said GigE/IP traffic into crossover ATM traffic; pass said crossover ATM traffic to said ATM switch over said ATM connection; receive ATM traffic from said ATM switch over said ATM connection; recast said ATM traffic into crossover GigE/IP traffic; and pass said crossover GigE/IP traffic to said GigE/IP switch over said GigE/IP connection.

According to a further aspect the invention provides for a method of hybrid IP/ATM network termination comprising: receiving ATM traffic at an ATM NT module of a hybrid IP/ATM NT of a DSLAM; recasting said ATM traffic into crossover GigE/IP traffic at an IWF element of the hybrid IP/ATM NT; and transmitting said crossover GigE/IP traffic from a GigE/IP NT module of the hybrid IP/ATM NT.

In some embodiments of the invention the step of receiving ATM traffic comprises receiving ATM traffic at one of an ATM network interface and an ATM bus interface.

Some embodiments of the invention further provide for: receiving GigE/IP traffic at the GigE/IP NT module; recasting said GigE/IP traffic into crossover ATM traffic at the IWF element; and transmitting said crossover ATM traffic from the ATM NT module over one of an ATM network interface and an ATM bus interface.

In some embodiments of the invention recasting said ATM traffic comprises: extracting a payload and a VPI/VCI from ATM cells of the ATM traffic; finding in a look-up table a VLAN ID corresponding to said VPI/VCI; and inserting said payload into Ethernet packets of the GigE/IP crossover traffic, ensuring the Ethernet packets are tagged with the VLAN ID, generating said crossover GigE/IP traffic.

According to another aspect, the invention provides for a method of hybrid IP/ATM network termination comprising: receiving ATM traffic at one of: an ATM network interface of an ATM NT module of a hybrid IP/ATM NT of a DSLAM; and an ATM bus interface connected to an ATM LT card of the DSLAM; recasting said ATM traffic into crossover GigE/IP traffic at an IWF element of the hybrid IP/ATM NT; transmitting said crossover GigE/IP traffic from a GigE/IP NT module of the hybrid IP/ATM NT; receiving GigE/IP traffic at the GigE/IP NT module; recasting said GigE/IP traffic into crossover ATM traffic at the IWF element; and transmitting said crossover ATM traffic from the hybrid IP/ATM NT over one of the ATM network interface and the ATM bus interface.

### BRIEF DESCRIPTION OF THE DRAWINGS

The features and advantages of the invention will become more apparent from the following detailed description of the preferred embodiment(s) with reference to the attached figures, wherein:

FIG. 1A is a block diagram of a known ATM NT;

FIG. 1B is a block diagram of a known GigE/IP NT;

FIG. 2 is a block diagram of a hybrid IP/ATM NT according to a preferred embodiment of the invention;

FIG. 3 is a block flow diagram of hybrid IP/ATM network termination in which ATM traffic is recast into GigE/IP traffic according to another embodiment of the invention; and

FIG. 4 is a block flow diagram of hybrid IP/ATM network termination in which GigE/IP traffic is recast into ATM traffic according to another embodiment of the invention.

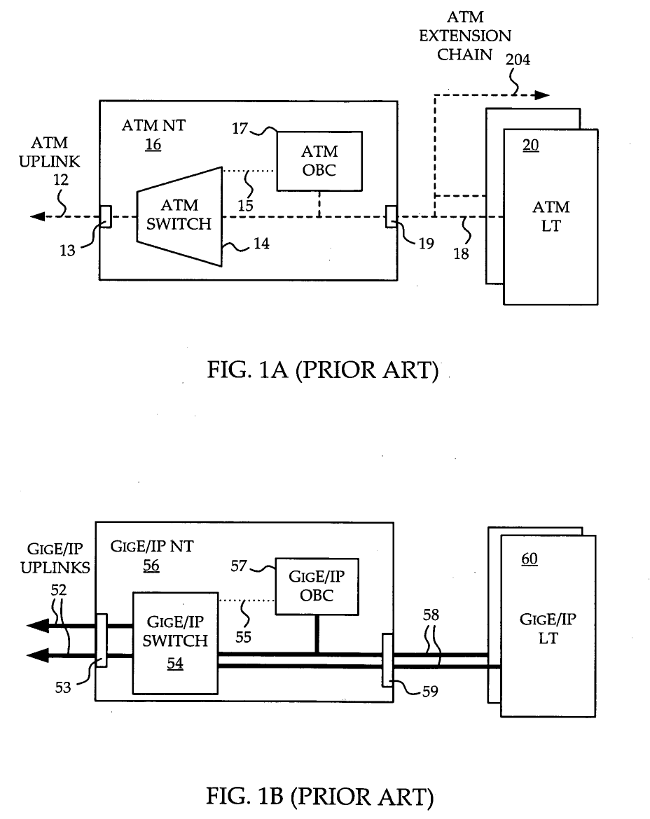

It is noted that in the attached figures, like features bear similar labels.

### DETAILED DESCRIPTION OF THE PREFERRED EMBODIMENTS

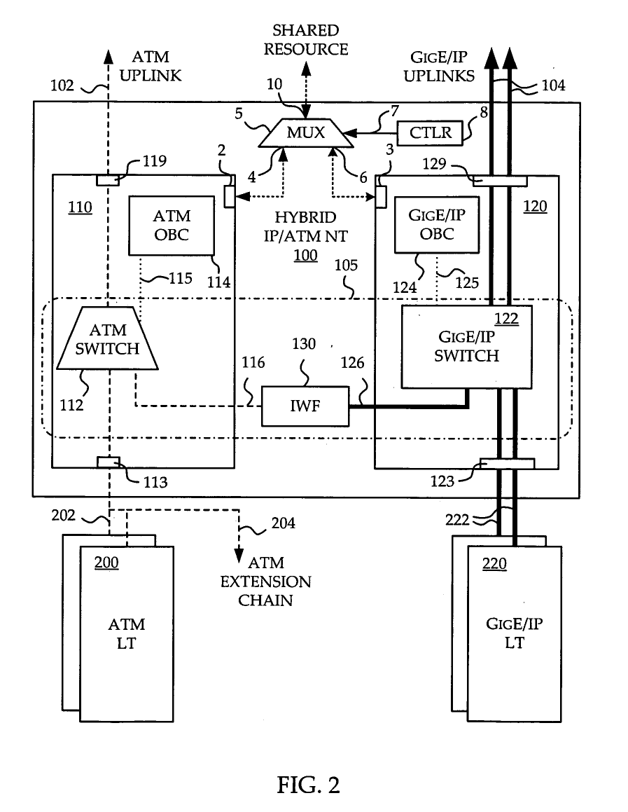

Referring to FIG. 2, a hybrid IP/ATM NT 100 in accordance with the preferred embodiment of the invention will now be discussed in terms of structure.

The hybrid IP/ATM NT 100 has an ATM network interface 119 connected to an ATM uplink 102 such as an OC12, OC3, DS3, or DS1. The ATM network interface 119 is coupled to an ATM switch 112 on the hybrid IP/ATM NT 100. The ATM switch 112 is coupled to an ATM bus interface 113 which is connected to an ATM bus 202. The ATM switch 112 is coupled over an ATM switch control line 115 to an ATM OBC 114 of the hybrid IP/ATM NT 100. The ATM switch 112 is coupled by an ATM connection 116 to an inter-working function (IWF) element 130. The IWF element 130 could be a network processor element typically used in existing GigE/IP LT cards to recast ATM streams into GigE/IP streams and to recast GigE/IP streams into ATM streams. It follows therefore that in some embodiments the IWF element 130 can be made using existing designs for hardware typically used elsewhere.

The hybrid IP/ATM NT 100 has a GigE/IP network interface 129 connected to GigE/IP uplinks 104. The GigE/IP network interface 129 is coupled to a GigE/IP switch 122 on the hybrid IP/ATM NT 100. The GigE/IP switch 122 is coupled to a GigE/IP bus interface 123 which is connected to a GigE/IP star bus 222. The GigE/IP switch 122 is coupled by a GigE/IP connection 126 to the IWF element 130. The GigE/IP switch 122 is coupled over a GigE/IP switch control line 125 to a GigE/IP OBC 124.

The ATM OBC 114, the ATM switch control line 115, the ATM switch 112, the ATM network interface 119, the ATM bus interface 113, and an interface 2 for shared resources are collectively referred to as the ATM NT module 110 of the hybrid IP/ATM NT 100. The ATM NT module 110 is connected via an ATM bus 202 to ATM LT cards 200 and via the ATM extension chain 204 to other ATM devices if any. The ATM LT cards 200 are standard ATM LT cards that could be used in known ATM DSLAMs. Here they are shown connected by the ATM bus 202 to the ATM bus interface 113 of the hybrid IP/ATM NT 100 and may form part of a hybrid IP/ATM DSLAM.

The GigE/IP OBC 124, the GigE/IP switch control line 125, the GigE/IP switch 122, the GigE/IP network interface 129, an interface 3 for shared resources, and the GigE/IP bus interface 123 are collectively referred to as the GigE/IP NT module 120 of the hybrid IP/ATM NT 100. The GigE/IP NT module 120 is connected over a GigE/IP star bus 222 to GigE/IP LTs 220. The GigE/IP NT module 120 is designed to work with GigE/IP interfaces and hence existing network equipment based on ATM technology are used with the ATM NT module 110. The GigE/IP LT cards 220 are standard GigE/IP LT cards that could be used in known GigE/IP DSLAMs. Here they are shown connected by the GigE/IP star bus 222 to the GigE/IP bus interface 123 of the hybrid IP/ATM NT 100 card and may form part of a hybrid IP/ATM DSLAM.

Collectively the GigE/IP switch 122, GigE/IP connection 126, the IWF element 130, the ATM connection 116, and the ATM switch 112 are referred to as an IP/ATM bridge 105. The GigE/IP NT module 120 is therefore understood to be coupled by the IP/ATM bridge 105 to the ATM NT module 110.

An NT card in a known DSLAM will typically have interfaces to resources including other cards, the backplane of the DSLAM, and external peripherals associated with the DSLAM. In an ATM DSLAM the ATM NT card would have these interfaces, while in a GigE/IP DSLAM the GigE/IP NT card would have these interfaces. To avoid duplication of all the resources interfaced with the hybrid IP/ATM NT card 100, the ATM NT module 110 and the GigE/IP NT module 120 of the hybrid IP/ATM NT 100 card share these resources. A shared resource is connected to the hybrid IP/ATM NT 100 at a single resource interface 10 of a resource sharing switch multiplexer 5. The resource sharing switch multiplexer 5 has a first access interface 4 connected to an interface 2 of the ATM NT module 110. The resource sharing switch multiplexer 5 also has a second access interface 6 connected to an interface 3 of the GigE/IP NT module 120. A control input 7 to the resource sharing switch multiplexer 5 is coupled to a resource sharing controller 8.

The hybrid IP/ATM NT 100 shown in FIG. 2 will now be discussed in terms of function.

The ATM NT module 110 functions as an ATM NT providing ATM network termination and control functionality with an ATM aggregation uplink. The ATM NT module 110 is designed to work with ATM interfaces and supports existing xDSL services to end users such as HSI over ADSL by multiplexing ATM traffic over the ATM bus 202 to and from the ATM LT cards 200. The ATM NT module 110 communicates with the network over its ATM network interface 119 to uplink 102 using OC12, OC3, DS3, and DS1, and others. The hybrid IP/ATM NT 100 is capable of communicating with existing ATM based hardware such as existing ATM LT cards, and provides support for existing ATM system interfaces such as the ATM network interface 119. The ATM NT module 110 has its own independent central processing unit (ATM OBC 114) and provides ATM network termination. The ATM NT module 110 also takes care of the management of the ATM LT cards 200 over the ATM bus 202. As such, the ATM NT module 110 of the hybrid IP/ATM NT 100 provides all of the functions of a known ATM NT so that the hybrid IP/ATM NT 100 is compatible with ATM network infrastructure allowing continued use of existing ATM hardware such as racks, shelves, and ATM LT cards from existing ATM DSLAMs. The ATM OBC 114 performs the necessary control functions for the ATM NT module 110 including controlling the ATM switch 112 by transmitting control commands over the ATM switch control line 115, and managing the ATM LT cards 200 over the ATM bus 202.

The GigE/IP NT module 120 functions as a GigE/IP NT providing GigE/IP network termination and control functionality with GigE/IP aggregation. The GigE/IP NT module 120 provides more bandwidth both on its GigE/IP network interface 129 and through its GigE/IP bus interface 123, over the GigE/IP star bus 222 and to the GigE/IP LT cards 220 than the ATM NT module 110 does on its ATM network interface 119 and through its ATM bus interface 113 over the ATM bus 202 to the ATM LT cards 200. The GigE/IP NT module 120 takes part in the provision of more enhanced features in comparison to the ATM NT module 110. Since the GigE/IP NT module 120 has a GigE/IP network interface for interfacing with multiple GigE/IP uplinks 104 towards the network, it can provide over high speed DSL such as SHDSL and VDSL, very high speed services such as Video, Voice, VoIP, IPTV, and HSI to end customers and allows for such capabilities as TV broadcasting using phone lines. The GigE/IP NT module 120 is designed to work with GigE/IP interfaces, and communicates with the network over its GigE/IP based GigE/IP network interfaces 129. The GigE/IP NT module 120 serves end users by multiplexing network traffic over the GigE/IP star bus 222 to and from the GigE/IP LT cards 220. The hybrid IP/ATM NT 100 is capable of communicating with existing GigE/IP based hardware such as GigE/IP LT line cards, and provides support for existing GigE/IP system interfaces for connecting to the GigE/IP uplinks 104. The GigE/IP NT module 120 has an Ethernet-based switching core (GigE/IP switch 122) with per-slot connectivity at GigE rate and has its own central processing unit (GigE/IP OBC 124) and performs GigE/IP EMAN (Ethernet Metro Area Network) network termination. The GigE/IP NT module 120 also takes care of the management of the GigE/IP LT cards 220 over the GigE/IP star bus 222. As such, the GigE/IP NT module 120 of the hybrid IP/ATM NT 100 provides all of the functions of a known GigE/IP NT so that the hybrid IP/ATM NT 100 can bring GigE/IP functionality to an ATM infrastructure, the hybrid IP/ATM NT 100 being compatible with ATM style racks, shelves, alarm monitoring systems, and other support systems. The GigE/IP OBC 124 performs the necessary control functions for the GigE/IP NT module 120 including controlling the GigE/IP switch 122 by transmitting control commands over the GigE/IP switch control line 125 and managing the GigE/IP LT cards 220 over GigE/IP bus 222.

The GigE/IP NT module 120 and the ATM NT module 110 act independently of one another with the exception of some shared functions including backplane signaling and with the exception of their passing data between each other using the IP/ATM bridge 105.

The IP/ATM bridge 105 serves to pass or cross over network traffic from the GigE/IP NT module 120 to the ATM NT module 110 and from the ATM NT module 110 to the GigE/IP NT module 120. Network traffic that has crossed over the IP/ATM bridge 105 is hereinafter referred to as crossover traffic.

In the upstream direction from the ATM NT module 110 to the GigE/IP NT module 120, traffic traverses from ATM LT cards 200 over the ATM bus 202 to the ATM bus interface 113 of the ATM NT module 110 as ATM traffic. The ATM traffic enters the ATM switch 112 which routes the ATM traffic over the ATM connection 116 to the IWF element 130. The IWF element 130 serves to recast the ATM traffic in the form of an ATM data stream into a GigE/IP data stream generating crossover GigE/IP traffic. In the particular implementation of the preferred embodiment this recasting is carried out by extracting the payload and VPI/VCI (virtual path identifier/virtual channel identifier) identifier from the ATM cells of the ATM data stream, finding in a look-up table the VLAN ID corresponding to the VPI/VCI, and finally inserting the payload into Ethernet packets of the GigE/IP data stream ensuring they are tagged with the corresponding VLAN ID. The crossover GigE/IP traffic traverses the GigE/IP connection 126 to the GigE/IP switch 122 of the GigE/IP NT module 120 where it is routed through the GigE/IP network interface 129 and over appropriate upstream GigE/IP uplinks 104.

In the upstream direction from the GigE/IP NT module 120 to the ATM NT module 110, traffic traverses from the GigE/IP LT cards 220 over the GigE/IP star bus 222 through the GigE/IP bus interface 123 of the GigE/IP NT module 120 to the GigE/IP switch 122 as GigE/IP traffic. The GigE/IP switch 122 routes the GigE/IP traffic over the GigE/IP connection 126 to the IWF element 130. The IWF element 130 serves to recast the GigE/IP traffic in the form of a GigE/IP data stream into an ATM data stream generating crossover ATM traffic. In the particular implementation of the preferred embodiment this recasting is carried out by extracting the payload and VLAN ID from the Ethernet packets of the GigE/IP data stream, finding in a look-up table the VPI/VCI identifier corresponding to the VLAN ID, and finally inserting the payload into ATM cells of the ATM data stream ensuring they have the corresponding VPI/VCI identifier. The crossover ATM traffic traverses the ATM connection 116 to the ATM NT module 110 at the ATM switch 112 where it is routed through the ATM network interface 119 and over the upstream ATM uplink 102.

In the downstream direction from the GigE/IP NT module 120 to the ATM NT module 110, GigE/IP traffic from the upstream network from the GigE/IP uplinks 104 traverses through the GigE/IP network interface 129 to the GigE/IP switch 122 where it is routed over the GigE/IP connection 126 to the IWF element 130. As discussed above, the IWF element 130 serves to recast the GigE/IP traffic in the form of a GigE/IP data stream, while ensuring a desired VLAN ID to VPI/VCI mapping, into an ATM data stream generating crossover ATM traffic. The crossover ATM traffic traverses the ATM connection 116 to the ATM switch 112 of the ATM NT module 110 which routes the crossover ATM traffic through the ATM bus interface 113 and over the ATM bus 202 to the ATM LT cards 200.

In the downstream direction from the ATM NT module 110 to the GigE/IP NT module 120, ATM traffic from the upstream network emerges from the ATM uplink 102 through the ATM network interface 119 and to the ATM switch 112 where it is routed over the ATM connection 116 to the IWF element 130. As discussed above, the IWF element 130 serves to recast the ATM traffic in the form of an ATM data stream, while ensuring a desired VPI/VCI to VLAN ID mapping, into a GigE/IP data stream generating crossover GigE/IP traffic. The crossover GigE/IP traffic traverses the GigE/IP connection 126 to the GigE/IP NT module 120 at the GigE/IP switch 122 which routes the crossover GigE/IP traffic through the GigE/IP bus interface 123 and over the GigE/IP star bus 222 to the GigE/IP LT cards 220.

The hybrid IP/ATM NT 100 by including an ATM NT module 110 and a GigE/IP NT module 120 provides an upgrade path from the ATM DSLAM platform to the GigE/IP DSLAM platform. Preferably, the IP/ATM NT 100 is housed in a DSLAM having slots in each shelf capable of supporting both types of line interface module, namely both ATM LTs and GigE/IP LTs.

The hybrid IP/ATM NT 100 extends the functionality of network termination cards to allow for simultaneous termination of two traffic types, ATM and GigE/IP.

Although all four possibilities for traffic flow have been described, subscribers on the GigE/IP LTs would typically only be connected to the network through the GigE/IP uplinks 104 due to the bandwidth bottle neck of the ATM uplink 102. Although subscribers on the ATM LTs could be connected to the network through the ATM uplink 102, they also could take advantage of the GigE/IP uplinks 104 via the IP/ATM bridge's IWF element 130 between the GigE/IP NT module 120 and the ATM NT module 110. Due to the relatively larger bandwidth of the GigE/IP uplinks 104, they do not act as a bottle neck for service to the ATM LT subscriber.

Since the hybrid IP/ATM NT 100 has a GigE/IP NT module 120 and an ATM NT module 110, the software to run the hybrid IP/ATM NT 100 may in fact be made up of two separate software entities to run these modules. The software entities could be completely independent of each other and could be completely separate software loads allowing for individual replacement, reset, or upgrade of one software entity without affecting the other software entity.

In the preferred embodiment the GigE/IP LTs 220 are controlled by software on the GigE/IP NT module 120 and the ATM LTs 200 are controlled by software on the ATM NT module 110.

One of the benefits of the hybrid IP/ATM NT 100 is its ability to be incorporated into a network infrastructure without requiring fundamental changes to existing external management strategies.

An external management system, such as an NMS (network management system), can present an integrated view of the system including the hybrid IP/ATM NT 100. Each of the GigE/IP NT module 120 and the ATM NT module 110 has its own separate management interface including a separate external IP address, a separate SNMP agent, and so on. This allows for the GigE/IP NT module 120 and the ATM NT module 110 to have separate network IDs, to be managed separately, and also to report their own alarms independently and separately.

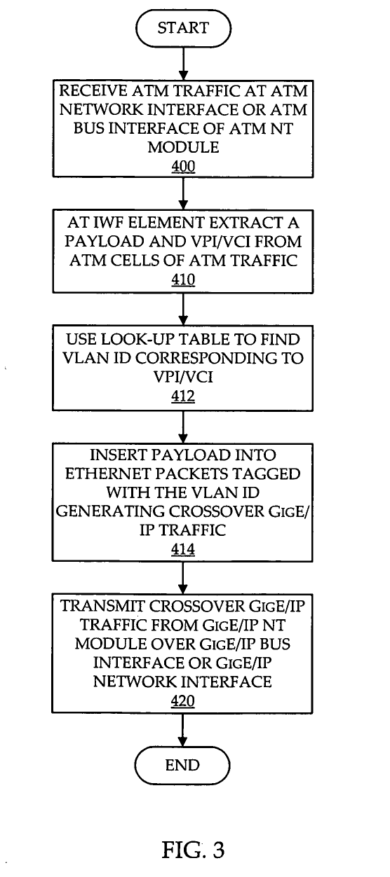

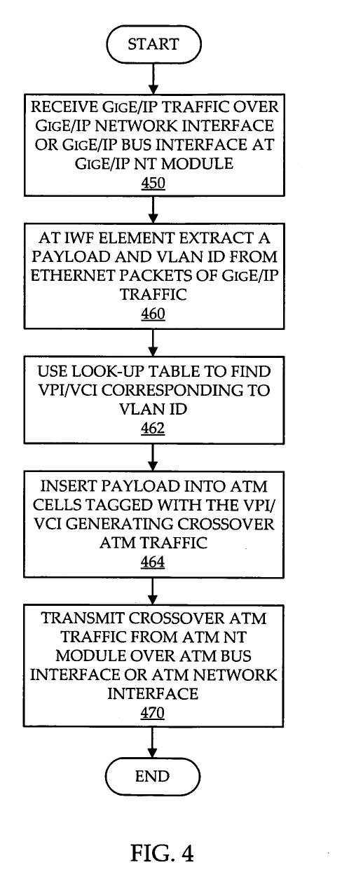

Referring also to FIGS. 3 and 4, hybrid IP/ATM network termination in a hybrid IP/ATM NT in which ATM traffic is recast into GigE/IP traffic and GigE/IP traffic is recast into ATM traffic according to an embodiment of the invention will now be discussed.

With respect to FIG. 3 in which ATM traffic is recast into GigE/IP traffic, ATM traffic is received at an ATM network interface of an ATM NT module or at an ATM bus interface of the ATM NT module at step 400. As discussed above, receiving traffic at the ATM network interface corresponds to downstream traffic whereas receiving traffic at the ATM bus interface corresponds to upstream traffic. This ATM traffic is recast into crossover GigE/IP traffic at an IWF element of the hybrid IP/ATM NT in steps 410, 412, and 414. In step 410, a payload and VPI/VCI (virtual path identifier/virtual channel identifier) identifier are extracted from the ATM cells of the ATM traffic. At step 412 a look-up table is used to find the VLAN ID corresponding to the VPI/VCI. At step 414 the payload is inserted into Ethernet packets ensuring they are tagged with the corresponding VLAN ID to generate crossover GigE/IP traffic. In step 420 the crossover GigE/IP traffic is transmitted from a GigE/IP NT module of the hybrid IP/ATM NT. As discussed above, transmission of traffic from a GigE/IP NT module may be in an upstream (GigE/IP network interface) direction or downstream (GigE/IP bus interface) direction.

With respect to FIG. 4 in which GigE/IP traffic is recast into ATM traffic, GigE/IP traffic is received at a GigE/IP NT module of the hybrid IP/ATM NT in step 450. As discussed above, receipt of traffic at a GigE/IP NT module may be from an upstream direction (GigE/IP network interface) or from a downstream direction (GigE/IP bus interface). This GigE/IP traffic is recast into crossover ATM traffic at an IWF element of the hybrid IP/ATM NT in steps 460, 462, and 464. In step 460, a payload and VLAN ID are extracted from the Ethernet packets of the GigE/IP traffic. At step 462 a look-up table is used to find the VPI/VCI identifier corresponding to the VLAN ID. At step 464, the payload is inserted into ATM cells ensuring they have the corresponding VPI/VCI identifier to generate crossover ATM traffic. In step 470 the crossover ATM traffic is transmitted over an ATM network interface of an ATM NT module of the hybrid IP/ATM NT or over an ATM bus interface of the ATM NT module. As discussed above transmission of traffic over the ATM network interface corresponds to upstream traffic and transmission of traffic over the ATM bus interface card corresponds to downstream traffic.

In general sharing of resources by the GigE/IP NT module 120 and the ATM NT module 110 is provided through the use of the resource sharing switch multiplexer 5. Signals over the control input 7 to the resource sharing switch multiplexer 5 from the resource sharing controller 8 determine which of the GigE/IP NT module 120 and the ATM NT module 110 has access to or is interfaced with the shared resource. The resource sharing controller 8 may be part of the GigE/IP NT module 120, or may be part of the ATM NT module 110, and particularly could be the GigE/IP OBC 124 or the ATM OBC 114 respectively. The resource sharing controller 8 could also be a third party or component.

An example resource shared by the GigE/IP NT module 120 and the ATM NT module 110 is an alarm card installed in the hybrid DSLAM. In this particular implementation the interfaces 2, 4, 3, 6, and 10 are all interfaces appropriate for the alarm card. The resource sharing switch controller 8 could be implemented by a semaphore set to cause the resource sharing switch multiplexer 5 to switch to the appropriate access interface 6, 4 to allow access by the GigE/IP NT module 120 or the ATM NT module 110. The semaphore could be set by a third party, by one or both of the GigE/IP OBC 124 and the ATM OBC 114.

Another example resource shared by the GigE/IP NT module 120 and the ATM NT module 110 is an interface to an external dumb terminal having a serial interface. In this particular implementation the resource sharing controller 8 snoops input from the dumb terminal entering the single resource interface 10 of the resource sharing switch multiplexer 5. When a particular control character input is detected by the resource sharing controller 8, the resource sharing controller 8 switches the resource sharing switch multiplexer 5 to the first access interface 4 to give access to the ATM NT module interface 2, and when a different particular control character input is detected by the resource sharing controller 8, the resource sharing controller 8 switches the resource sharing switch multiplexer 5 to the second access interface 6 to give access to the GigE/IP NT module interface 3. In some particular implementations, the resource sharing switch multiplexer 5 and the resource sharing controller 8 performing the snooping of the single resource interface 10 may be implemented on one of the GigE/IP NT module 120 and the ATM NT module 110.

Another example resource shared by the GigE/IP NT module 120 and the ATM NT module 110 is an Ethernet interface to, for example, a LAN having a first entity communicating with the ATM NT module 110 and a second entity communicating with the GigE/IP NT module 120. In this particular embodiment, the resource sharing controller 8 and the resource sharing switch multiplexer 5 are embodied in a single Ethernet switch. In this case the Ethernet switch would perform soft switching to ensure proper delivery of Ethernet packets to and from the ATM and GigE/IP NT modules 110, 120 and the first and second entities in the LAN.

Another example shared resource is an activity latch, typically used for setting activity of each of a pair of known NT cards. In the preferred embodiment of the hybrid IP/ATM NT 100, the card may function in duplex mode (two card configuration) or in simplex mode (a single card configuration). In duplex mode activity should only be requested from the activity latch for the hybrid IP/ATM NT 100 card if both the GigE/IP NT module 120 and the ATM NT module 110 are functioning and both requesting activity. In this case the request for activity binary signal from each of the GigE/IP NT module 110 and the ATM NT module 110 is interfaced into the resource sharing switch multiplexer 5. The resource sharing controller 8 snoops the request for activity from each of the ATM NT module 110 and the GigE/IP NT module 120. The resource sharing controller 8 is such that only when both requests for activity are present is a request for activity sent out of the single resource interface 10. In other embodiments the resource sharing switch multiplexer 5, and resource sharing controller 8 are combined into a series of logic gates which transmit a high signal over the single resource interface 10, only when both the GigE/IP NT module 120 and the ATM NT module 110 are requesting activity. In simplex mode, activity should be requested from the activity latch for the hybrid IP/ATM NT 100 card as long as either one of the GigE/IP NT module 120 and the ATM NT module 110 is functioning and requesting activity. In this mode the resource sharing controller 8 is such that when either request for activity is present, a request for activity is sent out of the single resource interface 10.

It should be understood that there are numerous implementations and variations for configuring resource sharing for the ATM NT module 110 and the GigE/IP NT module 120. Interfaces can be switched in response to internal, external, or third party control, and can be arranged for an interface which mostly receives input or for an interface which mostly sends output. Although only one shared resource, a single switch multiplexer 5, and a single shared resource controller 8 have been discussed, it should be understood that any number of different resources may be shared between the ATM NT module 110 and the GigE/IP NT module 120, as long as the hybrid IP/ATM NT 100 has the requisite number of switch multiplexers 5 and resource sharing controllers 8 and associated links and interfaces. In general any interface typically on an ATM NT card or a GigE/IP card can be shared between the ATM NT module 110 and the GigE/IP NT module 120 in similar manner to that of the preferred embodiment as discussed above.

Service providers looking to replace their large investment in existing ATM DSLAMs and ATM network infrastructure with GigE/IP DSLAMs and GigE/IP infrastructure are finding it difficult to switch due to the amount of the existing equipment and the cost that such a migration from ATM to GigE/IP entails.

A migration path from ATM DSLAMs to GigE/IP DSLAMs which allows for gradual introduction and switching from the old ATM equipment to new GigE/IP based equipment is preferred as part of a DSL services migration from an ATM network infrastructure to a GigE/IP network infrastructure.

Service providers can use the hybrid IP/ATM NT 100 as part of such a migration path from ATM DSLAMs to GigE/IP DSLAMs by providing a DSLAM with hybrid IP/ATM capability. The hybrid IP/ATM NT 100 immediately brings GigE/IP NT capabilities and support for GigE/IP LT line cards to an ATM infrastructure, while providing for gradual migration to a GigE/IP network infrastructure by allowing customers to re-use their existing ATM DSLAM infrastructure while replacing existing ATM DSLAMs. As hybrid IP/ATM NTs 100 are introduced into the ATM network infrastructure, existing ATM hardware, services, and system interfaces can be re-used with the hybrid IP/ATM NT 100 while new GigE/IP DSLAM capabilities are introduced into the network infrastructure. In this manner service providers can plan to integrate the GigE/IP based network topology into their networks without throwing away existing ATM based network topology. Most of the heavily deployed ATM based ATM DSLAM equipment may be re-used during the introduction of next generation GigE/IP DSLAM capabilities avoiding the large economical burden that would be associated with a massive decommissioning of ATM network infrastructure resources and the simultaneous deployment of all new GigE/IP based network infrastructure.

Some of the benefits of a hybrid IP/ATM NT 100 include its greater bandwidth support for GigE/IP LTs ( 1 Gig per LT), its simultaneous dual circuit and packet operation, its usefulness in providing a customer controlled. transition timeline from ATM to Ethernet, its preservation of the current ATM DSLAM installed base to reduce transition costs and its ability to maintain current ATM installations, ATM interfaces, and ATM connection provisioning for existing subscribers with its ATM capabilities. It allows for the existing ATM interfaces to be maintained as the various types of interfaces are supported by the hybrid NT. Deployed ATM systems can be upgraded with GigE/IP and high bandwidth fabric provided by the hybrid IP/ATM NT 100.

On the GigE/IP side the hybrid IP/ATM NT 100 supports the existing BRAS (broadband remote access server) based connection model for both HSI and IP Video subscribers, while enabling IPTV service for new and migrated subscribers. The hybrid IP/ATM NT 100 supports non-blocking aggregation/subscriber traffic via Gigabit Ethernet interfaces, provides additional GigE/IP Interfaces for new IPTV subscribers, and is full line rate capable and compatible with 1000 Base SX,LX and TX via Small Form-factor Pluggable (SFP) modules.

In general network service providers benefit from the ability to leverage deployed platforms and minimize operational discontinuities in the migration from ATM to GigE/IP. The upgrade process afforded by the hybrid IP/ATM NT 100 should take significantly less time than a drop-in-and-replace overlay type installation and represents a fast and cheap way for current customers to achieve significant video coverage for their subscribers.

It should be noted that the IP/ATM bridge 105, the ATM NT module 110, and the GigE/IP NT module 120 may be implemented in the hybrid IP/ATM NT 100 in many different ways. According to a preferred embodiment they are all part of a single hybrid IP/ATM NT card. In other embodiments the IWF element could be implemented on a GigE/IP NT card which acts as the GigE/IP NT module 120 and a daughter ATM NT card could be situated on the GigE/IP NT card, and would act as the ATM NT module. In other embodiments the IWF element could be implemented on an ATM NT card which acts as the ATM NT module 110 and a daughter GigE/IP NT card could be situated on the ATM NT card, and would act as the GigE/IP NT module. In other embodiments the IWF could be implemented on a daughter card. Many other implementation possibilities exist for the IP/ATM bridge 105, the ATM NT module 110, and the GigE/IP NT module 120 in accordance with the invention.

Although a GigE/IP switch, GigE/IP connection and GigE/IP network interfaces have been described in association with the preferred embodiments of the invention it is to be understood that the GigE/IP NT module operate at any speed and in general is comprised of Ethernet/IP based components such as an Ethemet/IP switch, an Ethernet/IP connection, Ethernet/IP network interfaces, Ethernet/IP bus interface, and an Ethemet/IP star bus.

The embodiments presented are exemplary only and persons skilled in the art would appreciate that variations to the embodiments described above may be made without departing from the spirit of the invention. The scope of the invention is solely defined by the appended claims.

We claim:

1. A hybrid IP/ATM NT for a DSLAM, the hybrid IP/ATM NT comprising:
a GigE/IP NT module for network termination and control of GigE/IP traffic flowing between a GigE/IP LT card and a GigE/IP uplink;
an ATM NT module for network termination and control of ATM traffic flowing between an ATM LT card and an ATM uplink; and
an IP/ATM bridge for recasting GigE/IP traffic received from the GigE/IP NT module into crossover ATM traffic and passing said crossover ATM traffic to the ATM NT module, and for recasting ATM traffic received from the ATM NT module into crossover GigE/IP traffic and passing said crossover GigE/IP traffic to the GigE/IP NT module.

2. A hybrid IP/ATM NT according to claim 1 wherein the GigE/IP NT module comprises a GigE/IP switch for switching GigE/IP traffic, wherein the ATM NT module comprises an ATM switch for switching ATM traffic, and wherein the IP/ATM bridge comprises an inter-working function (IWF) element connected to said GigE/IP switch and connected to said ATM switch, said IWF element adapted to:
recast GigE/IP traffic received from the GigE/IP switch into crossover ATM traffic;
transmit said crossover ATM traffic to said ATM switch;
recast ATM traffic received from the ATM switch into crossover GigE/IP traffic; and
transmit the crossover GigE/IP traffic to said GigE/IP switch.

3. A hybrid IP/ATM NT according to claim 2 wherein said IWF element is adapted to recast said GigE/IP traffic by:
extracting a first payload and a VLAN ID from Ethernet packets of the GigE/IP traffic;
finding in a look-up table a VPI/VCI (virtual path identifier/virtual channel identifier) corresponding to said VLAN ID; and
inserting the first payload into ATM cells of the ATM data stream, ensuring the ATM cells are tagged with the VPI/VCI to generate said crossover ATM traffic; and
wherein said IWF element is adapted to recast said ATM traffic by:
extracting a second payload and a VPI/VCI from ATM cells of the ATM traffic;
finding in said look-up table a VLAN ID corresponding to said VPI/VCI; and
inserting said second payload into Ethernet packets of the GigE/IP data stream, ensuring the Ethernet packets are tagged with the VLAN ID to generate said crossover GigE/IP traffic.

4. A hybrid IP/ATM NT according to claim 1 wherein the GigE/IP NT module comprises a GigE/IP OBC (on board controller) and manages the GigE/IP LT card, and wherein the ATM NT module comprises an ATM OBC and manages the ATM LT card.

5. A hybrid IP/ATM NT according to claim 1 wherein the ATM NT module is adapted to interface with standard ATM hardware and provide a standard ATM system interface.

6. A hybrid IP/ATM NT according to claim 5 wherein the ATM NT module comprises an ATM bus interface for connecting over an ATM bus to a standard ATM LT card and a standard ATM network interface for connecting to the ATM uplink.

7. A hybrid IP/ATM NT according to claim 2 further comprising:
a resource sharing switch multiplexer having a first access interface coupled to a first resource interface of the ATM NT module, a second access interface coupled to a second resource interface of the GigE/IP NT module, and a single resource interface coupled to a resource to be shared between the GigE/IP NT module and the ATM NT module; and
a resource sharing controller coupled to the resource sharing switch multiplexer for switching said resource sharing switch multiplexer for one of throughput between the first access interface and the single resource interface and throughput between the second access interface and the single resource interface.

8. A hybrid IP/ATM NT according to claim 7 wherein said resource sharing controller is adapted to store a semaphore having one of a first value and a second value, said resource sharing controller being responsive to said semaphore having said first value to switch said resource sharing switch multiplexer for said throughput between the first access interface and the single resource interface, and being responsive to said semaphore having said second value to switch said resource sharing switch multiplexer for said throughput between the second access interface and the single resource interface.

9. A hybrid IP/ATM NT according to claim 7 wherein the resource sharing controller is adapted to snoop signals traversing said single resource interface, and wherein said resource sharing controller performs said switching of said resource sharing switch multiplexer with use of said signals traversing said single resource interface.

10. A hybrid IP/ATM NT for a DSLAM according to claim 1 wherein the IP/ATM bridge comprises:
an inter-working function (IWF) element;
wherein the GigE/IP NT module comprises:
a GigE/IP bus interface for connecting to the GigE/IP LT card over a GigE/IP star bus;
a GigE/IP network interface for connecting to the GigE/IP uplink;
a GigE/IP switch connected to said GigE/IP bus interface and said GigE/IP network interface, for switching traffic flowing between the GigE/IP LT card and the GigE/IP uplink;
a GigE/IP OBC for managing the GigE/IP LT;
a GigE/IP connection coupling said GigE/IP switch to said IWF element;
wherein the ATM NT module comprises:
an ATM bus interface for connecting to the ATM LT card over an ATM bus;
an ATM OBC for managing the ATM LT;
an ATM network interface for connecting to the ATM uplink;
an ATM switch for switching traffic flowing between the ATM LT and the ATM uplink; and
an ATM connection coupling said IWF element to said ATM switch;
and wherein the IWF element is adapted to:
receive the GigE/IP traffic from said GigE/IP switch over said GigE/IP connection;
recast said GigE/IP traffic into crossover ATM traffic;
pass said crossover ATM traffic to said ATM switch over said ATM connection;
receive the ATM traffic from said ATM switch over said ATM connection;
recast said ATM traffic into crossover GigE/IP traffic; and
pass crossover GigE/IP traffic to said GigE/IP switch over said GigE/IP connection.

11. A method of hybrid IP/ATM network termination comprising:
receiving ATM traffic at an ATM NT module of a hybrid IP/ATM NT of a DSLAM;
recasting said ATM traffic into crossover GigE/IP traffic at an IWF element of the hybrid IP/ATM NT; and
transmitting said crossover GigE/IP traffic from a GigE/IP NT module of the hybrid IP/ATM NT.

12. A method of hybrid IP/ATM network termination according to claim 11 wherein the step of receiving ATM traffic comprises receiving ATM traffic at one of an ATM network interface and an ATM bus interface.

13. A method of hybrid IP/ATM network termination according to claim 12 wherein recasting said ATM traffic comprises:
extracting a payload and a VPI/VCI from ATM cells of the ATM traffic;
finding in a look-up table a VLAN ID corresponding to said VPI/VCI; and
inserting said payload into Ethernet packets of the GigE/IP crossover traffic, ensuring the Ethernet packets are tagged with the VLAN ID, generating said crossover GigE/IP traffic.

14. A method of hybrid IP/ATM network termination according to claim 11 further comprising:
receiving GigE/IP traffic at the GigE/IP NT module;
recasting said GigE/IP traffic into crossover ATM traffic at the IWF element; and
transmitting said crossover ATM traffic from the ATM NT module over one of an ATM network interface and an ATM bus interface.

15. A method of hybrid IP/ATM network termination comprising:
receiving ATM traffic at one of:
an ATM network interface of an ATM NT module of a hybrid IP/ATM NT of a DSLAM; and
an ATM bus interface connected to an ATM LT card of the DSLAM;
recasting said ATM traffic into crossover GigE/IP traffic at an IWF element of the hybrid IP/ATM NT;
transmitting said crossover GigE/IP traffic from a GigE/IP NT module of the hybrid IP/ATM NT;
receiving GigE/IP traffic at the GigE/IP NT module;
recasting said GigE/IP traffic into crossover ATM traffic at the IWF element; and
transmitting said crossover ATM traffic from the hybrid IP/ATM NT over one of the ATM network interface and the ATM bus interface.
